(19) United States
(12) Patent Application Publication
(10) Pub. No.: US 2006/0046692 A1
(43) Pub. Date: Mar. 2, 2006

(54) Techniques for establishing secure electronic communication between parties using wireless mobile devices

(76) Inventors: Lenka M. Jelinek, Portland, OR (US); Dean J. Sanvitale, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/928,659

(22) Filed: Aug. 26, 2004

(51) Int. Cl. H04M 1/66; H04M 1/68; H04M 3/16

(52) U.S. Cl. 455/411; 455/41.2; 713/168

(57) ABSTRACT

Use of electronic devices to communicate using a cryptographic key that has been exchanged by parties using mobile wireless devices. Two or more individuals may exchange identification information using a short-range wireless protocol so that the individuals may physically see and verify each other's identities, which may eliminate the need for a trusted third party to be involved in a security key exchange.

### TECHNICAL FIELD

Embodiments of the invention relate to secure communications. More particularly, embodiments of the invention relate to techniques for sharing security keys between parties using wireless mobile devices.

### BACKGROUND

Public Key Infrastructure (PKI) technology has been used to conduct secure electronic communications. PKI allows for relatively secure communications using public communications infrastructure by using a public and private key pair that is typically obtained and shared through a trusted intermediary, which is commonly referred to as a “trusted key authority.” The trusted key authority typically consists of a third party that operates a network of servers used to verify that a particular public key belongs to a particular individual.

Use of a trusted key authority results in a need for centrally available key servers accessible to all parties wishing to conduct secure communications, which has been too complicated and/or expensive to enter into widespread use. The lack of integration of PKI into popular electronic communications tools has also contributed to the relative paucity of electronic security in general and PKI in particular in the lives of most consumers and professionals. Thus, the general state of secure electronic communications is not sufficient to satisfy the existing need for convenient secure electronic communications.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a block diagram of one embodiment of an arrangement to exchange security keys using mobile electronic devices.

FIG. 2 is a block diagram of one embodiment of an arrangement for distributing security keys that have been exchanged using mobile electronic devices.

FIG. 3 is a block diagram of secure communications between electronic devices using security keys that have been exchanged using mobile electronic devices.

FIG. 4 is a flow diagram of one embodiment of a technique for distributing security keys using mobile electronic devices.

FIG. 5 is a block diagram of one embodiment of an electronic device.

### DETAILED DESCRIPTION

In the following description, numerous specific details are set forth. However, embodiments of the invention may be practiced without these specific details. In other instances, well-known circuits, structures and techniques have not been shown in detail in order not to obscure the understanding of this description.

The technique described herein provides the ability for electronic devices (e.g., computer systems, personal digital assistants (PDAs), set top boxes, network devices) to communicate using a cryptographic key that has been exchanged by parties using mobile wireless devices (e.g., cellular telephones, PDAs, palm top computers, ultra mobile computers). In one embodiment, two or more individuals may exchange identification information using wireless mobile devices, for example, cellular telephones or PDAs. The exchange may be accomplished using a short-range wireless protocol (e.g., Bluetooth, IEEE 802.11b/g) so that the individuals may physically see and verify each other's identities, which may eliminate the need for a trusted third party to be involved in a security key exchange.

The identification information may include a cryptographic key as well as other information. In one embodiment, the identification information may be in a standard format, for example, a vCard, which is commonly used to exchange identification information. In one embodiment, the identification information in the vCard (or other format) may include a public half of a public/private key pair belonging to the sending individual.

Keys that are exchanged using mobile devices may be synchronized with other electronic devices (e.g., computer systems) that belong to the receiving individuals. Once synchronization occurs, users who have conducted the identity exchange may securely communicate with each other using devices other than the mobile device used to exchange keys. This may allow the individuals to communicate in a secure manner over a public communications network. In one embodiment, a number of devices to which a key may be distributed may be limited to a pre-selected number.

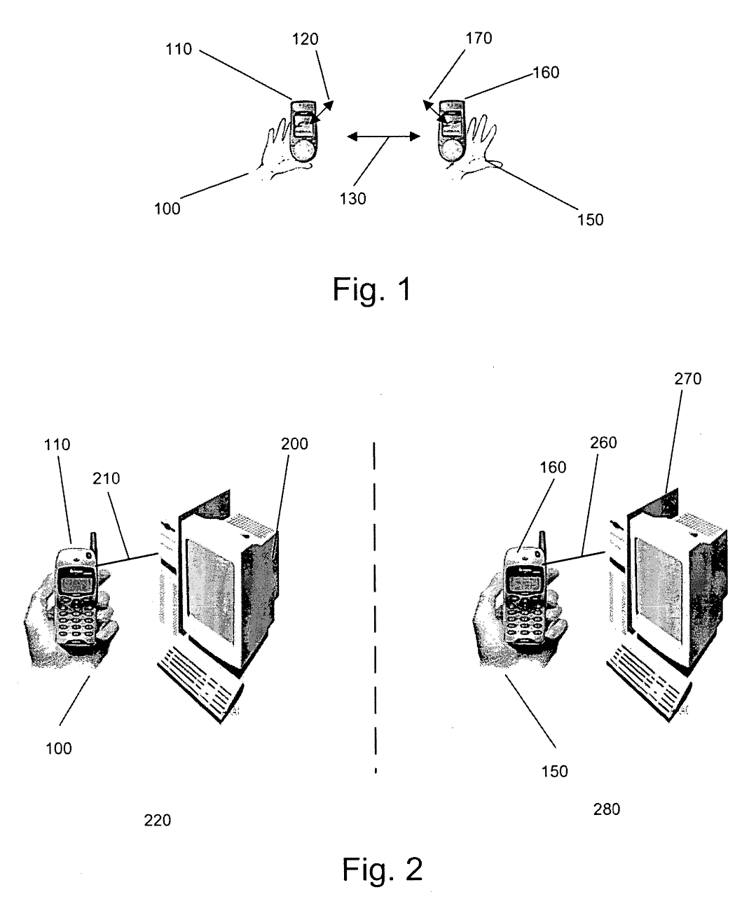

FIG. 1 is a block diagram of one embodiment of an arrangement to exchange security keys using mobile electronic devices. FIG. 1 illustrates a key exchange using cellular telephones; however, any wireless electronic device may be used to exchange security keys.

In one embodiment, the electronic devices (e.g., 110, 160) used to exchange security keys may be able to communicate using multiple wireless protocols. Using cellular telephones as an example, electronic devices 110 and 160 may transmit and receive signals 120 and 170 according to any cellular telephone protocol known in the art. The electronic devices may be further configured to communicate using signals 130 conforming to relatively short-range wireless protocols. The short-range wireless protocols may include, for example, Bluetooth, IEEE 802.11b and/or IEEE 802.11g.

Bluetooth protocols are described in “Specification of the Bluetooth System: Core, Version 1.1,” published Feb. 22, 2001 by the Bluetooth Special Interest Group, Inc. Associated as well as previous or subsequent versions of the Bluetooth standard may also be supported. IEEE 802.11b corresponds to IEEE Std. 802.11b-1999 entitled “Local and Metropolitan Area Networks, Part 11: Wireless LAN Medium Access Control (MAC) and Physical Layer (PHY) Specifications: Higher-Speed Physical Layer Extension in the 2.4 GHz Band,” approved Sep. 16, 1999 as well as related documents. IEEE 802.11g corresponds to EEE Std. 802.11g-2003 entitled “Local and Metropolitan Area Networks, Part 11: Wireless LAN Medium Access Control (MAC) and Physical Layer (PHY) Specifications, Amendment 4: Further Higher Rate Extension in the 2.4 GHz Band,” approved Jun. 27, 2003 as well as related documents.

In operation, user 100 may agree with user 150 to exchange security keys in order to engage in subsequent secure communications. User 100 may cause electronic device 110 to communicate with electronic device 160 belonging to user 150, for example, by pressing one or more keys and/or buttons on a keypad. In one embodiment, users 100 and 150 exchange security keys with electronic devices 110 and 160 using short-range wireless communications protocols. Wired communications may also be used, for example, by using a relatively short cable to allow users 100 and 150 to visually verify each other's identity.

The format of the security key to be exchanged may take any format. For example, electronic devices 110 and 160 may exchange vCards that may include one or more security keys corresponding to users 100 and 150, respectively. The vCard specification makes use of the “person” object defined by the CCITT X.500 Series Recommendation for Directory Services and can be considered an extension of the CCITT X.500 Series Recommendation. The Internet Mail Consortium is responsible for vCard standards and related protocols. Other data formats, whether conforming to an industry standard or not, may also be used.

By using short-range wireless communications users 100 and 150 may visually confirm the parties involved in the key exchange. This may eliminate the need to use a trusted key authority to exchange keys between users 100 and 150. Wired communications to exchange keys between users 100 and 150 may also eliminate the need to use a trusted key authority to exchange keys between users 100 and 150.

FIG. 2 is a block diagram of one embodiment of an arrangement for distributing security keys that have been exchanged using mobile electronic devices. After exchanging security keys, user 100 may have the security key for user 150 stored on electronic device 110. Similarly, user 150 may have the security key for user 100 stored on electronic device 160.

User 100 may then transfer the security key for user 150 from electronic device 110 to electronic device 200 over communications link 210. Electronic device 200 may be any type of electronic device including, for example, a computer system, a set top box, a PDA, etc. Communications link 210 may be any type of wired or wireless communications link known in the art. Similarly, user 150 may transfer the security key for user 100 to electronic device 270 over communications link 260. Electronic device 210 may be any type of electronic device including, for example, a computer system, a set top box, a PDA, etc. Communications link 260 may be any type of wired or wireless communications link known in the art. In one embodiment, electronic device 200 is in a location 220 that is geographically remote from location 280 where electric device 270 is located.

After transfer of the security key for user 150 from electronic device 110 to electronic device 200 and transfer of the security key for user 100 from electronic device 160 to electronic device 270 the users may engage in secure communications using electronic devices 200 and 270. That is, electronic devices 200 and 270 may be used for secure communications using keys that were acquired without use of a trusted key authority. Users 100 and 150 were able to exchange security keys without a trusted key authority by exchanging keys with short-range wireless protocols after visually verifying the identity of the party with which a security key is exchanged.

In another embodiment, communication between electronic devices 200 and 270 may be accomplished in a non-secure manner. For example, users 100 and 150 may exchange security keys using electronic devices 110 and 160 as described above. Additional information, for example, selected computer Internet Protocol (IP) addresses or other identifying information may be exchanged. The identifying information (e.g., IP addresses) may be distributed and used to establish a connection for direct communications. This communication may be accomplished in a secure or a non-secure manner.

That is, in addition to using security keys during network communications, the security keys may be used with the mobile electronic devices to exchange information that may be used to establish a connection between non-co-located electronic devices. This may allow users of mobile electronic devices to securely exchange information that may be used for subsequent communications that may or may not utilize the security keys for the communications.

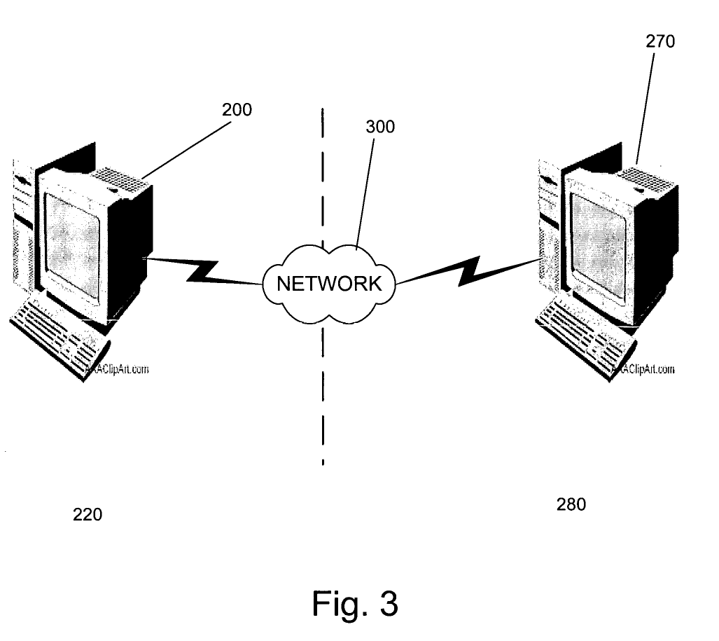

FIG. 3 is a block diagram of secure communications between electronic devices using security keys that have been exchanged using mobile electronic devices. After receiving security keys from mobile electronic devices, electronic devices 200 and 270 may communicate over network 300 using the security keys. Any type of security keys and/or any type of secure communications protocol known in the art may be used for secure communications.

In one embodiment, the security keys may be distributed from the mobile electronic devices to more than one target electronic device. In one embodiment, the number of recipient electronic devices may be limited. For example, a user may receive a security key via an exchange using a cellular telephone as described above. The received security key may be distributed to a computer system, a set top box and a PDA having wireless communication functionality. Distribution of security keys from the mobile electronic device may be accomplished using any communications protocol known in the art.

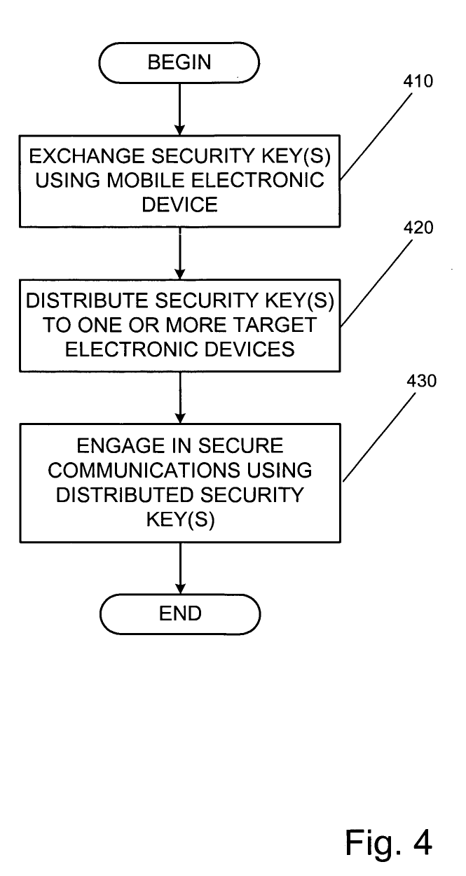

FIG. 4 is a flow diagram of one embodiment of a technique for distributing security keys using mobile electronic devices. In one embodiment, security keys to be used for secure communications between two or more parties may be exchanged using mobile electronic devices having wireless communication capabilities, 410. The mobile electronic devices may include, for example, cellular telephones, PDAs, wrist watches, writing instruments, automobiles, or any other device having wireless communications capability.

As discussed above, short-range wireless communications protocols may be used to allow the users exchanging security keys to visually verify the identity of the recipient of the security key. Any short-range wireless communication protocol known in the art may be used. The data to be transferred may be in any format, for example, a vCard may include additional information including name and contact information for the user providing the security key. Other data formats that include other information may be used or the security key may be exchanged without additional information.

The security keys may then be distributed from the mobile electronic devices to other electronic devices, 420. Distribution allows non-mobile electronic devices, for example, desktop computer systems or set top boxes, to use security keys for secure communications without interacting with a trusted key authority. This may simplify the distribution of security keys among some users.

Once the security keys are distributed, the electronic devices may engage in secure communications, 430. Any type of secure communications known in the art that uses security keys may be used. For example, any type of public key infrastructure (PKI) secure communications may be used with the security keys that have been distributed.

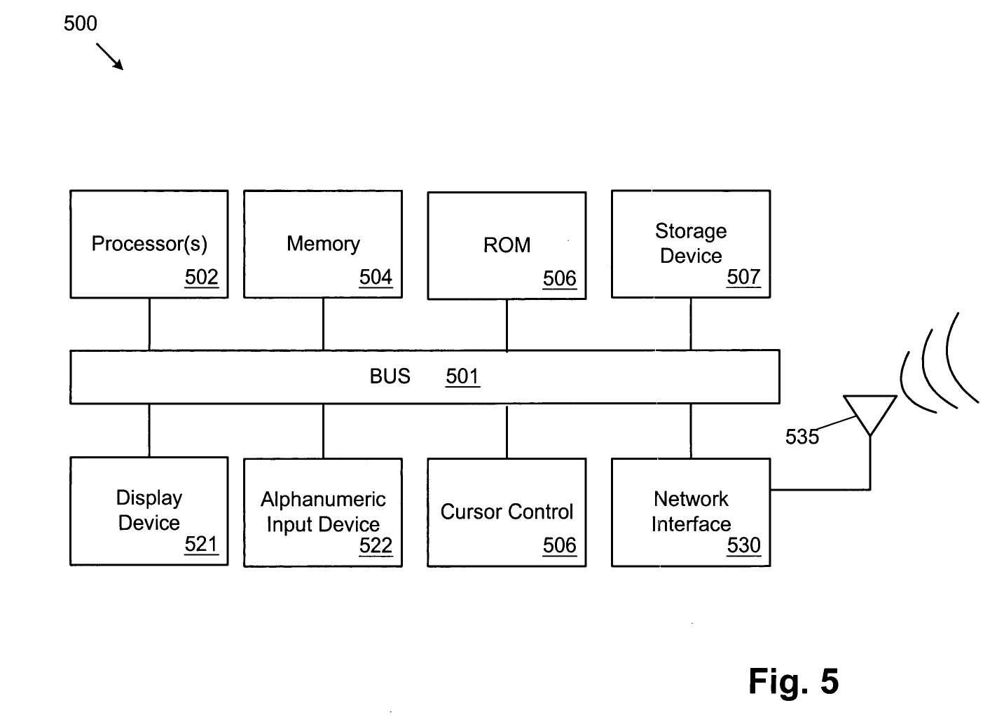

In one embodiment, the technique of FIG. 4 may be implemented as sequences of instructions executed by one or more electronic systems. The instructions may be stored by the electronic device or the instructions can be received by the electronic device (e.g., via a network connection). FIG. 5 is a block diagram of one embodiment of an electronic system. The electronic system illustrated in FIG. 5 is intended to represent a range of electronic systems, for example, computer systems, network access devices, PDAs, cellular telephones, etc. Alternative systems, whether electronic or non-electronic, can include more, fewer and/or different components.

Electronic system 500 may include bus 501 or other communication device to communicate information, and processor 502 may be coupled to bus 501 to process information. While electronic system 500 is illustrated with a single processor, electronic system 500 may include multiple processors and/or co-processors. Electronic system 500 may further include random access memory (RAM) or other dynamic storage device 504 (referred to as memory), coupled to bus 501 to store information and instructions to be executed by processor 502. Memory 504 also may be used to store temporary variables or other intermediate information during execution of instructions by processor 502.

Electronic system 500 may also include read only memory (ROM) and/or other static storage device 506 coupled to bus 501 to store static information and instructions for processor 502. Data storage device 507 may be coupled to bus 501 to store information and instructions. Data storage device 507 such as a magnetic disk or optical disc and corresponding drive may be coupled to electronic system 500.

Electronic system 500 may also be coupled via bus 501 to display device 521, such as a cathode ray tube (CRT) or liquid crystal display (LCD), to display information to a user. Alphanumeric input device 522, including alphanumeric and other keys, may be coupled to bus 501 to communicate information and command selections to processor 502. Another type of user input device is cursor control 523, such as a mouse, a trackball, or cursor direction keys to communicate direction information and command selections to processor 502 and to control cursor movement on display 521. Electronic system 500 further may include network interface 530 to provide access to a network, such as a local area network. Network interface(s) 530 may include, for example, a wireless network interface having antenna 535, which may represent one or more antenna(e). In one embodiment, network interface(s) 530 may provide access to a local area network, for example, by conforming to IEEE 802.11b and/or IEEE 802.11g standards, and/or the wireless network interface may provide access to a personal area network, for example, by conforming to Bluetooth standards. In addition to, or instead of, communication via wireless LAN standards, network interface(s) 530 may provide wireless communications using, for example, Time Division, Multiple Access (TDMA) protocols, Global System for Mobile Communications (GSM) protocols, Code Division, Multiple Access (CDMA) protocols, and/or any other type of wireless communications protocol.

Instructions may be provided to memory from a storage device, such as magnetic disk, a read-only memory (ROM) integrated circuit, CD-ROM, DVD, via a remote connection (e.g., over a network via network interface 530) that may be either wired or wireless providing access to one or more electronically-accessible media, etc. In alternative embodiments, hard-wired circuitry may be used in place of or in combination with software instructions. Thus, execution of sequence of instructions is not limited to any specific combination of hardware circuitry and software instructions.

An electronically accessible medium includes any mechanism that provides (i.e., stores and/or transmits) content (e.g., computer executable instructions) in a form readable by an electronic device (e.g., a computer, a personal digital assistant, a cellular telephone). For example, a machine-accessible medium includes read only memory (ROM); random access memory (RAM); magnetic disk storage media; optical storage media; flash memory devices; electrical, optical, acoustical or other form of propagated signals (e.g., carrier waves, infrared signals, digital signals); etc.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
establishing, with a local electronic device, a wireless communication session with a remote electronic device using a short-range wireless protocol;
receiving a security key with the local electronic device from the remote electronic device without use of a trusted key authority using the short-range wireless protocol;
transmitting, with the local electronic device, the security key from the remote electronic device to an other electronic device; and
using the other electronic device to engage in secure communications using the security key.

2. The method of claim 1 wherein the short-range wireless protocol conforms to a Bluetooth standard.

3. The method of claim 1 wherein the short-range wireless protocol conforms to an IEEE 802.11 standard.

4. The method of claim 1 wherein the local electronic device comprises a cellular telephone.

5. The method of claim 1 wherein the local electronic device comprises a personal digital assistant (PDA).

6. The method of claim 1 wherein receiving the security key with the local electronic device from the remote electronic device comprises receiving data formatted as a vCard that includes the security key.

7. The method of claim 1 wherein transmitting, with the local electronic device, the security key from the remote electronic de-vice to an other electronic device comprises distributing the security key to up to a pre-selected number of electronic devices.

8. The method of claim 1 wherein the local electronic device transmits the security key to the other electronic device without use of a trusted key authority.

9. An apparatus comprising:
a control circuit;
a memory coupled with the control circuit to store a security key;
a wireless receiver coupled with the control circuit and the memory to receive the security key from a remote wireless device in response to a first predetermined user input, wherein the security key is received via communications using a short-range wireless protocol, and further wherein the security key is received without use of a trusted key authority; and
a wireless transmitter coupled with the control circuit and the memory to transmit the security key to an other electronic device in response to a second predetermined user input without use of a trusted key authority.

10. The apparatus of claim 9 wherein the short-range wireless protocol conforms to a Bluetooth standard.

11. The apparatus of claim 9 wherein the short-range wireless protocol conforms to an IEEE 802.11 standard.

12. The apparatus of claim 9 wherein the security key is received as data formatted as a vCard that includes the security key.

13. The apparatus of claim 9 wherein the control circuit limits distribution of the security key to up to a pre-selected number of electronic devices.

14. An article comprising a computer-readable medium having stored thereon instructions that, when executed, cause one or more processors to:
establish, with a local electronic device, a wireless communication session with a remote electronic device using a short-range wireless protocol;
receive a security key with the local electronic device from the remote electronic device without use of a trusted key authority using the short-range wireless protocol;
transmit, with the local electronic device, the security key from the remote electronic device to an other electronic device; and
use the other electronic device to engage in secure communications using the security key.

15. The article of claim 14 wherein the short-range wireless protocol conforms to a Bluetooth standard.

16. The article of claim 14 wherein the short-range wireless protocol conforms to an IEEE 802.11 standard.

17. The article of claim 14 wherein the local electronic device comprises a cellular telephone.

18. The article of claim 14 wherein the local electronic device comprises a personal digital assistant (PDA).

19. The article of claim 14 wherein the instructions that cause the one or more processors to receive the security key with the local electronic device from the remote electronic device comprise instructions that, when executed, cause the one or more processors to receive data formatted as a vCard that includes the security key.

20. The article of claim 14 wherein the instructions that cause the one or more processors to transmit, with the local electronic device, the security key from the remote electronic device to an other electronic device comprise instructions that, when executed, cause the one or more processors to distribute the security key to up to a pre-selected number of electronic devices.

21. The article of claim 14 wherein the local electronic device transmits the security key to the other electronic device without use of a trusted key authority.

22. A system comprising:
one or more substantially omni-directional antennae;
a control circuit;
a memory coupled with the control circuit to store a security key;
a wireless receiver coupled with the control circuit, at least one of the antennae and the memory to receive the security key from a remote wireless device in response to a first predetermined user input, wherein the security key is received via communications using a short-range wireless protocol, and further wherein the security key is received without use of a trusted key authority; and
a wireless transmitter coupled with the control circuit, at least one of the antennae and the memory to transmit the security key to an other electronic device in response to a second predetermined user input without use of a trusted key authority.

23. The system of claim 22 wherein the short-range wireless protocol conforms to a Bluetooth standard.

24. The system of claim 22 wherein the short-range wireless protocol conforms to an IEEE 802.11 standard.

25. The system of claim 22 wherein the security key is received as data formatted as a vCard that includes the security key.

26. The system of claim 22 wherein the control circuit limits distribution of the security key to up to a pre-selected number of electronic devices.

27. A method comprising:
establishing, with a local cellular-enabled electronic device, a wireless communication session with a remote cellular-enabled electronic device using a non-cellular, short-range wireless protocol;
receiving a security key with the local cellular-enabled electronic device from the remote cellular-enabled electronic device without use of a trusted key authority using the non-cellular, short-range wireless protocol;
transmitting, with the local cellular-enabled electronic device, the security key from the remote cellular-enabled electronic device to an other electronic device without use of a trusted key authority; and
using the other electronic device to engage in secure communications using the security key.

28. The method of claim 27 wherein the short-range wireless protocol conforms to a Bluetooth standard.

29. The method of claim 27 wherein the short-range wireless protocol conforms to an IEEE 802.11 standard.

30. The method of claim 27 wherein the local electronic device comprises a personal digital assistant (PDA).

31. A method comprising:
establishing, with a local mobile electronic device, a wireless communication session with a remote mobile electronic device using a short-range wireless protocol and utilizing a security key;
receiving a identifying information corresponding to an electronic device with the local mobile electronic device from the remote mobile electronic device;
transmitting, with the local mobile electronic device, the identifying information from the remote mobile electronic device to an other electronic device; and
using the other electronic device to engage in communications with the electronic device corresponding to the identifying information.

32. The method of claim 31 wherein the identifying information comprises an Internet Protocol (IP) address for the electronic device corresponding to the identifying information.

33. The method of claim 31 wherein the short-range wireless protocol conforms to a Bluetooth standard.

34. The method of claim 31 wherein the short-range wireless protocol conforms to an IEEE 802.11 standard.

35. The method of claim 31 wherein the local mobile electronic device comprises a cellular telephone.

36. The method of claim 31 wherein the local mobile electronic device comprises a personal digital assistant (PDA).

37. An article comprising a computer-readable medium having stored thereon instructions that, when executed, cause one or more processors to:
establish, with a local cellular-enabled electronic device, a wireless communication session with a remote cellular-enabled electronic device using a short-range wireless protocol and utilizing a security key;
receive a identifying information corresponding to an electronic device with the local cellular-enabled electronic device from the remote cellular-enabled electronic device;
transmit, with the local cellular-enabled electronic device, the identifying information from the remote cellular-enabled electronic device to an other electronic device; and
use the other electronic device to,engage in communications with the electronic device corresponding to the identifying information.

38. The article of claim 37 wherein the identifying information comprises an Internet Protocol (IP) address for the electronic device corresponding to the identifying information.

39. The article of claim 37 wherein the short-range wireless protocol conforms to a Bluetooth standard.

40. The article of claim 37 wherein the short-range wireless protocol conforms to an IEEE 802.11 standard.

41. The article of claim 37 wherein the local cellular-enabled electronic device comprises a cellular telephone.

42. The article of claim 37 wherein the local cellular-enabled electronic device comprises a personal digital assistant (PDA).
